(19) United States
(12) Patent Application Publication
(10) Pub. No.: US 2004/0051976 A1
(43) Pub. Date: Mar. 18, 2004

(54) Confocal microscope with diffractively formed virtual pinhole array

(75) Inventors: Jacob Karin, Ramat Gan (IL); Michael Golub, Rehovot (IL)

Correspondence Address: DR. MARK FRIDMAN LTD, c/o Bill Polkinghorn, Discovery Dispatch, 9003 Florin Way, Upper Marlboro, MD, 20772, US

(73) Assignee: ACCRETECH (ISRAEL) LTD

(21) Appl. No.: 10/230,207

(22) Filed: Aug. 29, 2002

(51) Int. Cl. G02B 9/00; G02B 9/08

(52) U.S. Cl. 359/738

(57) ABSTRACT

A confocal microscope with diffractively formed virtual pinhole array includes a laser light source configuration configured to generate a beam of parallel light and a diffractive optical element deployed in a path of the beam. The diffractive optical element is configured to generate a virtual pinhole array in which a plurality of small spots are formed in a focal plane. A confocal microscope assembly is deployed with its illumination plane coincident with the virtual pinhole array.

### FIELD AND BACKGROUND OF THE INVENTION

The present invention relates to microscopy and, in particular, it concerns a confocal microscope with a diffractively formed virtual pinhole array.

It is known to employ confocal microscopy for high-resolution inspection of surfaces. The essence of confocal microscopy or confocal imaging is described in U.S. Pat. No. 3,013,467 to Minsky in which light from a “point” or small spot illumination source (pinhole) is focused to a small spot on the specimen and light reflected (or transmitted) from the illuminated spot is in turn focused to a small spot (pinhole) sensor. This configuration may be combined with a scanning system to build up a high resolution image of an specimen, for example, a semiconductor wafer. Further examples of confocal microscopy may be found in U.S. Pat. Nos. 4,806,004; 5,239,178; and 6,285,019.

In order to increase efficiency in a scanning confocal system, multi-spot arrangements are typically used. An example of such a system may be found in U.S. Pat. No. 5,239,178 to Derndinger et al., FIG. 1 of which is reproduced herein as FIG. 1. (A detailed description of the elements identified by reference numerals therein may be found in the Derndinger et al. patent itself, and for the sake of conciseness, will not be reproduced here.) In this typical case, a multi-spot confocal microscope configuration in implemented using an array of pinholes, with or without an accompanying lens array, in front of an extended source of light to generate a plurality of point sources. These point sources are then brought into focus on the sample by the action of an objective lens. The reflected beams are directed back through the same pinhole array, or another matching array of pinholes.

The use of a pinhole array as a light source is clearly very inefficient. In order to obtain the benefits of confocal imaging, the spot size must be small. Typically, the spacing between spots is between two and ten times the spot diameter. This dictates that only a small proportion of light incident on the pinhole array is transmitted. In the case of a 1:10 ratio of spot diameter to inter-spot spacing, only 4% of the incident light is transmitted. Efficiency may be somewhat enhanced by employing a lens array to provide enhanced illumination of the pinhole array, but this greatly increases complexity and cost, and creates alignment problems. Where a white light source (i.e., a lamp) can be used, this inefficiency is not critical since the low transmittance can be compensated for by using high power light source. However, as resolution requirements increase, shorter wavelength illumination is required, typically in the UV or DUV (Deep UV) spectral range. In these ranges, strong light sources are not readily available. For example, A CW laser with output at 266 nm is currently available at only 0.5 watt output.

U.S. Pat. No. 6,208,411 to Vaez-Iravani departs from the concept of point source illumination, instead achieving a similar result using a diffractive beam-multiplication element. This diffractive element splits an incident beam of parallel light into a predefined number of diverging beams with properties similar to the incident beam. A telescope is then required to recombine the beams and direct them towards a beam-splitter and diverted towards the sample. The remainder of the system is similar to a conventional confocal arrangement.

The use of a diffractive beam-multiplication element offers much greater efficiency of illumination than is possible using the alternative techniques described above. Nevertheless, the system of Vaez-Iravani suffers from a number of disadvantages. Most notably, the system requires an additional telescope to recombine the diverging beams. In addition to increasing complexity and cost, the additional optical components adversely affect the quality of the light wavefront and the separation between light spots. Furthermore, the description in column 4 and FIG. 1 of Vaez-Iravani indicate that the center of the beam splitter is conjugated with the center of the plane of the diffractive element. Such an arrangement requires complicated mechanical alignment between three optical components which further complicates the described system.

Reference is made parenthetically to an article entitled “Diffractive lenses for chromatic confocal imaging” (Dobson et al., APPLIED OPTICS Vol. 36, No. 20, Jul. 10, 1997). This article describes use of a DOE in the context of confocal microscopy for providing frequency-to-depth mapping.

There is therefore a need for an illumination configuration for confocal microscopy which would maintain the simplicity of a simple pinhole array geometry while enhancing the efficiency of illumination.

### SUMMARY OF THE INVENTION

The present invention is a confocal microscope with a diffractively formed virtual pinhole array.

According to the teachings of the present invention there is provided, a confocal microscope with diffractively formed virtual pinhole array comprising: (a) a laser light source configuration configured to generate a beam of parallel light; (b) a diffractive optical element deployed in a path of the beam of parallel light, the diffractive optical element being configured to generate from the beam a plurality of parallel output beams in a predefined spaced relation; and (c) a confocal microscope assembly having an illumination plane, the confocal microscope assembly being deployed with the plurality of output beams incident on the illumination plane so as to provide a pinhole array illumination pattern.

According to a further feature of the present invention, the diffractive optical element is configured to generate a two-dimensional array of the parallel beams.

According to a further feature of the present invention, there is also provided at least one lens deployed so as to focus each of the parallel output beams at a focal plane, wherein the focal plane substantially coincides with the illumination plane.

### BRIEF DESCRIPTION OF THE DRAWINGS

The invention is herein described, by way of example only, with reference to the accompanying drawings, wherein:

FIG. 1 is a schematic side view of a conventional confocal microscope system;

FIG. 2 is a schematic side view of a confocal microscope, constructed and operative according to the teachings of the present invention, employing a diffractive optical element to form a virtual pinhole array; and

FIG. 3 is a schematic side view illustrating the properties of a diffractive optical element for use in the microscope of FIG. 2.

### DESCRIPTION OF THE PREFERRED EMBODIMENTS

The present invention is a confocal microscope with a diffractively formed virtual pinhole array.

The principles and operation of microscopes according to the present invention may be better understood with reference to the drawings and the accompanying description.

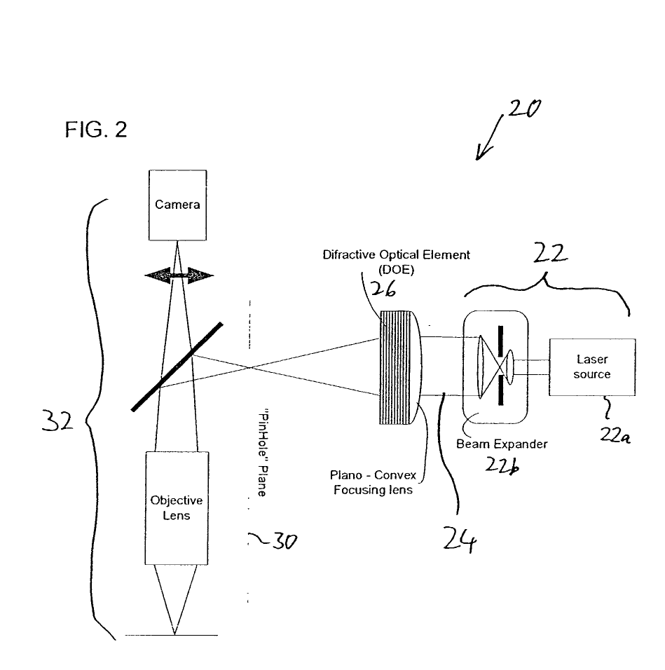

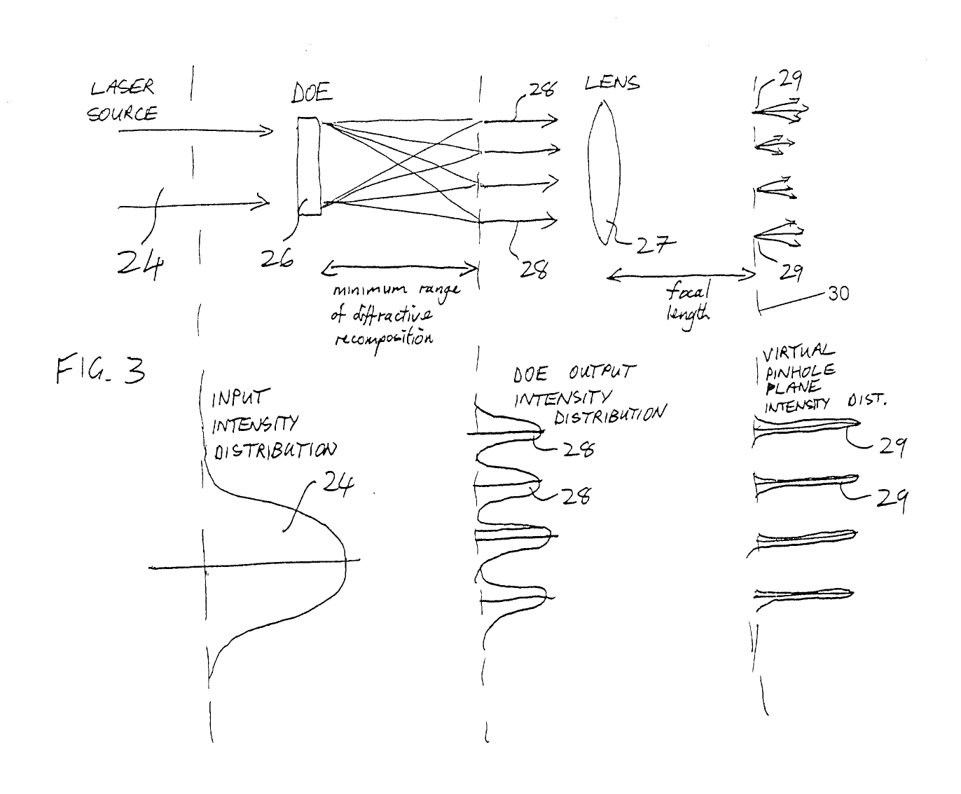

Referring now to the drawings, FIG. 2 shows a confocal microscope, generally designated 20, constructed and operative according to the teachings of the present invention, which employs a diffractively formed array of parallel beams, preferably focused to a plane to provide a virtual pinhole array. Generally speaking, microscope 20 includes a laser light source configuration 22 configured to generate a beam 24 of parallel light. A diffractive optical element (“DOE”) 26 is deployed in a path of beam 24. As seen more clearly in FIG. 3, diffractive optical element 26 is configured to direct light from incident beam 24 to generate an array of parallel spaced beams 28. Beyond the minimum range of diffractive recomposition defined for the DOE, these beams are preferably miniature reproductions of the input illumination beam with similar properties and direction of propagation. Preferably, although not necessarily, beams 28 are also focused by a lens arrangement (preferably a single convex lens 27) so as to focus beams 28 to a focal plane 30, thereby forming a virtual pinhole array containing a corresponding array of particularly small sharp spots 29 formed in a focal plane or “pinhole plane” 30. Microscope 20 also includes a confocal microscope assembly 32 which has an illumination plane at which an illuminated pinhole array would normally be located. Instead, confocal microscope assembly 32 is here deployed with the illumination plane coincident with the virtual pinhole array in pinhole plane 30. In a more basic implementation without any lens arrangement, the positioning of the DOE is less critical, so long as the illumination plane is beyond the minimum recomposition range of the DOE.

It will be immediately apparent that the present invention provides a structurally simple and yet efficient solution for confocal microscopy by maintaining geometrical equivalence to a pinhole array while providing efficiency of light transmission typically in the range of 85%-95% compared with 4% for a standard pinhole array. In fact, the resulting array of light spots also provide light sources of much higher quality than a conventional pinhole array. Specifically, each spot is an exact replica of the original light beam at reduced intensity and smaller diameter. The quality of the laser light source is preserved, such that a Gaussian beam at the input will still be a Gaussian beam at the output. This is in contrast to the output of a conventional pinhole array in which the output is an approximation of point sources which generate interference between them, resulting in increased cross talk and noise in the final measurements.

Before addressing features of the invention in more detail, it will be useful to clarify certain terminology as used in the context of the present description. Specifically, the term “virtual pinhole array” is used herein in the description and claims to refer to an illumination pattern which provides an effect similar to a pinhole array without requiring a physical pinhole array (i.e., without an opaque sheet drilled with spaced-apart holes). It should be noted that the word “virtual” is used here to denote that the pinhole array effect is simulated in free space without a conventional pinhole array structure being present at the pinhole plane. In optics terminology, however, the virtual pinhole array is a “real image” in the sense that it can be visualized by projection onto a surface.

Turning now to the features of microscope 20 in more detail, light source configuration 22 preferably includes a laser source 22a. The laser source may be of any suitable type and wavelength. For highest resolution, a UV or DUV laser source is used. For convenience of terminology, all suitable wavelengths will be referred to herein generically as “light”, whether they fall within or outside the visible part of the electromagnetic wave spectrum.

The light from laser source 22a then preferably passes through a beam expander 22b so that the width of the beam is increased to correspond substantially to the size of DOE 26. Beam expanders are well known in the art. Accordingly, this element will not be described further herein.

The DOE may be designed to generate a line of spots, or more preferably, a two-dimensional array of spots, in a predefined focal plane. The technology for implementing such diffractive elements is known, and elements of this type are commercially available, both as standard items and customized to particular specifications, from Holo-Or Ltd. of Rehovot, Israel, and other sources. The focal plane, referred to here as the “pinhole plane”, contains the virtual pinhole array, i.e., an array of focused bright spots in a common plane, that replaces the physical pinhole array element of conventional confocal arrangements.

For clarity of presentation, lens 27 has been illustrated schematically in FIG. 3 as a separate element located beyond and spaced from the DOE. It should be noted, however, that the lens or lens arrangement 27 is in practice more preferably combined with DOE 26, and may be located in the optical path on the input side of the DOE as illustrated in FIG. 2. This and other possible variant implementations of the optical layout will be clear to one ordinarily skilled in the art. In all cases, however, the use of a DOE which generates parallel output beams provides a profound simplification of the optical system compared to that of the Vaez-Iravani reference mentioned above.

Preferably, the pinhole pattern has a ratio of inter-beam spacing to beam diameter of approximately 10:1. Preferably, the pinhole beam width is between about 10 and about 50 times the wavelength of light used, and most preferably approximately 20 times the wavelength. Thus, in one preferred example using 266 nm illumination, a preferred pattern has approximately 5 micron spot diameter and inter-spot spacing of about 50 microns (center-to-center).

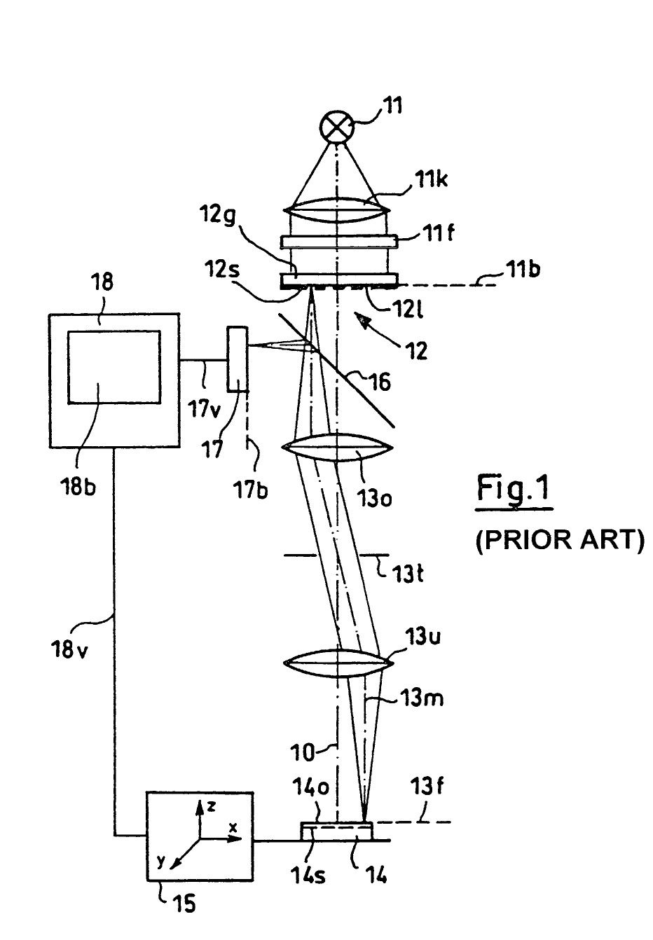

The remaining parts of microscope 20, referred to collectively as confocal microscope assembly 32, are essentially the same as the components of a conventional confocal microscope from the illumination plane onwards. Accordingly, these components will not be described here in detail. For clarity of presentation, various optical components have been omitted or represented highly schematically in the attached drawings, as will be clear to one ordinarily skilled in the art. By way of one non-limiting example, the confocal microscope assembly 32 may be implemented substantially according to the teachings of U.S. Pat. No. 5,239,178 to Derndinger et al. (as reproduced here in FIG. 1), or any other known arrangement in which the diffractively produced virtual pinhole array of the present invention replaces a physical pinhole array or other illumination grid.

It will be appreciated that the above descriptions are intended only to serve as examples, and that many other embodiments are possible within the spirit and the scope of the present invention.

What is claimed is:

1. A confocal microscope with diffractively formed virtual pinhole array comprising:
(a) a laser light source configuration configured to generate a beam of parallel light;
(b) a diffractive optical element deployed in a path of said beam of parallel light, said diffractive optical element being configured to generate from said beam a plurality of parallel output beams in a predefined spaced relation; and
(c) a confocal microscope assembly having an illumination plane, said confocal microscope assembly being deployed with said plurality of output beams incident on the illumination plane so as to provide a pinhole array illumination pattern.

2. The confocal microscope of claim 1, wherein said diffractive optical element is configured to generate a two-dimensional array of said parallel beams.

3. The confocal microscope of claim 1, further comprising at least one lens deployed so as to focus each of said parallel output beams at a focal plane, wherein said focal plane substantially coincides with said illumination plane.
